(19) United States
(12) Patent Application Publication
(10) Pub. No.: US 2023/0410217 A1
(43) Pub. Date: Dec. 21, 2023

(54) Basic Salary Calculation Program

(71) Applicant: BUSINESS LINK, INC., Toyohashi-City (JP)

(72) Inventor: Yukitaka NISHIKAWA, Toyohashi-City (JP)

(21) Appl. No.: 18/456,200

(22) Filed: Aug. 25, 2023

Related U.S. Application Data
(63) Continuation of application No. PCT/JP2021/010335, filed on Mar. 15, 2021.

(51) Int. Cl. G06Q 40/12

(52) U.S. Cl. CPC G06Q 40/12

(57) ABSTRACT

A basic salary position Pr based on a difference between a previous basic salary Xb and a policy line C, which is an average value of the lower limit amount A and the upper limit amount B of the basic salary, and a positional salary increase rate Rp based on the basic salary position Pr is calculated. Then, a total salary increase rate R including the positional salary increase rate Rp is calculated, and the rate R is multiplied by the basic salary Xb to calculate a salary increase amount Dn. Then, the basic salary Xb and the amount Dn are added to calculate an increased basic salary Xn. Thus, calculation of the basic salary Xn doesn't require preliminary creation of and reference to a pay scale in which the basic salary is changed in steps, the basic salary Xn can be acquired easily through calculation.

### CROSS REFERENCE TO RELATED APPLICATIONS

The present application is a continuation application of International Application No. PCT/JP2021/010335, filed on Mar. 15, 2021. The entire disclosure of the above application is expressly incorporated by reference herein.

### BACKGROUND

### Technical Field

The present invention relates to a basic salary calculation program.

### Related Art

Japanese Patent No. 4004700 (for example, paragraphs 0101 to 0103, FIGS. 9 and 10) discloses that a wage after salary increase is determined by checking a previously created job wages table (pay scale) according to a total evaluation point determined for each employee. Specifically, an amount obtained by varying a wage stepwise in the order of “number” is set in a column of wage of the job wages table and a number after salary increase is checked against a number of the job wages table. An amount in the column of wage in the job wages table corresponding to a matched number is determined as the wage after salary increase.

### SUMMARY

However, when the job wages table is created, the amount in the column of wage need be calculated for each number. Therefore, a number of times at which the amount in the column of wage is calculated is increased with increase in number and creation of the job wages table requires time and labor. Further, when the wage after salary increase is determined, the number after salary increase must be checked against a number in the job wages table on a staff member-by-staff member basis to acquire the wage after salary increase. Because of the foregoing, a problem used to arise when the wage after salary increase is acquired, a heavy burden is imposed on an operator.

The present invention has been made to solve the above-mentioned problem and it is an object of the present invention to provide the basic salary calculation program that allows an increased basic salary to be easily calculated without use of a pay scale.

To achieve the object, the basic salary calculation program according to the present invention perform basic salary calculation processing by a computer equipped with a storage unit, and the storage unit is caused to function as a staff member information storage means that stores a previous basic salary for each staff member. The computer performs: a staff member information acquisition step of acquiring the previous basic salary of the staff member from the staff member information storage means; a PL acquisition step of acquiring a policy line for the basic salary; a position calculation step of calculating a basic salary position based on a difference between the previous basic salary acquired at the staff member information acquisition step and the policy line acquired at the PL acquisition step; a positional salary increase rate calculation step of calculating the positional salary increase rate corresponding to the basic salary position calculated at the position calculation step; a total salary increase rate calculation step of calculating a total salary increase rate that is the salary increase rate including the positional salary increase rate calculated at the positional salary increase rate calculation step; and a basic salary calculation step of using a total salary increase rate calculated at the total salary increase rate calculation step and the previous basic salary acquired at the staff member information acquisition step to calculate the increased basic salary of the staff member.

According to the basic salary calculation program described in Aspect 1, the previous basic salary of a staff member is acquired from the staff member information storage means and the basic salary position is calculated based on a difference between the previous basic salary and the policy line for basic salary. Then, a total salary increase rate is calculated as a salary increase rate including the positional salary increase rate corresponding to the basic salary position. The increased basic salary is calculated using the total salary increase rate and the previous basic salary. That is, when an increase basic salary is obtained, necessity for previously creating a pay scale in which a basic salary is varied stepwise and referring to the pay scale is obviated. This brings about an effect of the increased basic salary being easily acquirable.

According to the basic salary calculation program described in Aspect 2, in addition to the effect brought about by the basic salary calculation program described in Aspect 1, the following effect is brought about: the positional salary increase rate is calculated from an enumeration function using the basic salary position as input. A specific description will be given. The positional salary increase rate in the policy line is taken as a PL positional salary increase rate. When the previous basic salary is less than the policy line, the enumeration function outputs the positional salary increase rate equal to or more than the PL positional salary increase rate as the positional salary increase rate. With this positional salary increase rate, the previous basic salary less than the policy line can be significantly increased.

Meanwhile, when the previous basic salary is more than the policy line, the enumeration function outputs a salary increase rate equal to or less than the PL positional salary increase rate as the positional salary increase rate. With this positional salary increase rate, salary increase from the previous basic salary more than the policy line can be suppressed. These bring about an effect of the capability to suppress a disparity in basic salary between staff members.

According to the basic salary calculation program described in Aspect 3, in addition to the effect brought about by the basic salary calculation program described in Aspect 2, the following effect is brought about: the enumeration function is set based on the policy line and the PL positional salary increase rate, the reference position basic salary that is the basic salary deviating from the policy line by a predetermined amount, and the reference positional salary increase rate at the reference position basic salary. That is, the following advantage is brought about by setting how much the reference positional salary increase rate outputted from the enumeration function at the reference position basic salary deviating from the policy line by the predetermined amount should be added to or subtracted from the PL positional salary increase rate: the magnitude of the positional salary increase rate can be set.

By setting the policy line, the PL positional salary increase rate and the reference position basic salary, or the reference positional salary increase rate according to performance, salary increase capital, or a result of labor-management negotiation, the positional salary increase rate corresponding to them can be obtained.

Examples of enumeration functions include linear function, quadratic function, and cubic function.

According to the basic salary calculation program described in Aspect 4, in addition to the effect brought about by the basic salary calculation program described in Aspect 3, the following effect is brought about: either a lower limit amount or an upper limit amount of the basic salary is set for the reference position basic salary and the positional salary increase rate at the lower limit amount or upper limit amount of the basic salary set for the reference position basic salary is set for the reference positional salary increase rate.

As a result, the enumeration function is set based on the policy line and the PL positional salary increase rate, and, the lower limit amount or upper limit amount of the basic salary and the positional salary increase rate at the lower limit amount or upper limit amount of the basic salary. That is, the following advantage is brought about by setting how much the reference positional salary increase rate at the lower limit amount or upper limit amount of the basic salary should be added to or subtracted from the PL positional salary increase rate: the magnitude of the positional salary increase rate can be easily set.

According to the basic salary calculation program described in Aspect 5, in addition to the effect brought about by the basic salary calculation program described in any of Aspects 2 to 4, the following effect is brought about: a total salary increase rate is calculated by a standard salary increase rate and the positional salary increase rate. Since the standard salary increase rate is the salary increase rate in the policy line, the standard salary increase rate can be taken as a “standard level” at the total salary increase rate. Therefore, when the previous basic salary is less than the policy line, the total salary increase rate is comprised of the standard salary increase rate at the standard level and the positional salary increase rate higher than the PL positional salary increase rate and thus, a deviation from the policy line can be eliminated by early increasing the previous basic salary less than the policy line.

Meanwhile, when the previous basic salary is more than the policy line, the total salary increase rate is comprised of the standard salary increase rate and the positional salary increase rate equal to or lower than the PL positional salary increase rate. Therefore, salary increase from the previous basic salary more than the policy line is suppressed and deviation of the basic salary from the policy line can be suppressed. Because of the foregoing, an effect of the capability to suppress disparity in the basic salary between staff members.

In addition, the following effect is brought about by varying the standard salary increase rate according to performance, salary increase capital, a result of labor-management negotiation, or the like: the standard level of the total salary increase rate can be flexibly varied according to the foregoing.

According to the basic salary calculation program described in Aspect 6, in addition to the effect brought about by the basic salary calculation program described in Aspect 5, the following effect is brought about: the base salary increase rate obtained by dividing a multiplied value, obtained by multiplying the standard salary increase rate and the policy line, by the previous basic salary is calculated and the total salary increase rate is calculated by the base salary increase rate and the positional salary increase rate. A salary increase amount is calculated by multiplying the total salary increase rate and the previous basic salary, and the increased basic salary is calculated by adding the salary increase amount to the previous basic salary. An amount (hereafter, referred to as “base amount”) equivalent to the base salary increase rate of the salary increase amount is equivalent to an amount obtained by multiplying the base salary increase rate by the previous basic salary, that is, equivalent to an amount obtained by multiplying the standard salary increase rate by the policy line. Such a base amount does not depend on a fluctuating basic salary position or the previous basic salary; therefore, the base amount can be taken as the “standard level” at the salary increase amount.

Therefore, when the previous basic salary is less than the policy line, the salary increase amount depends on the base amount as the standard level and an amount resulting from the positional salary increase rate equal to or higher the PL positional salary increase rate; therefore, the previous basic salary less than the policy line can be early increased to eliminate deviation from the policy line. Meanwhile, when the previous basic salary is more than a policy line, the salary increase amount depends on a base amount and an amount resulting from the positional salary increase rate equal to or lower than the PL positional salary increase rate; therefore, increase in the previous basic salary more than the policy line is suppressed and a deviation of the basic salary from the policy line can be suppressed. These bring about the effect of the capability to suppress the disparity in the basic salary between staff members.

Further, the following effect is brought about by varying the standard salary increase rate or the policy line according to performance, salary increase capital, a result of labor-management negotiation, or the like: A base amount to be the standard level of the salary increase amount can be flexibly varied according to the foregoing.

Further, by grasping the base amount, an amount equivalent to the positional salary increase rate of the increased basic salary can be grasped. As a result, the following effect is also brought about: How much the increased basic salary was added or subtracted based on the positional salary increase rate, that is, the basic salary position can be easily grasped.

According to the basic salary calculation program described in Aspect 7, in addition to the effect brought about by the basic salary calculation program described in Aspects 5 or 6, the following effect is brought about: the following effect is brought about by acquiring the standard salary increase rate corresponding to an evaluation of a staff member: the fruit from the staff member's job can be incorporated into the total salary increase rate. Further, when a staff member's evaluation is incorporated into the standard salary increase rate, an influence of the height of the staff member's evaluation on the total salary increase rate can be made more independent of the basic salary position as compared with when the evaluation is incorporated into the positional salary increase rate corresponding to the basic salary position. As a result, the following effect is also brought about: the height of a staff member's evaluation can be appropriately incorporated into the increased basic salary.

According to the basic salary calculation program described in Aspect 8, in addition to the effect brought about by the basic salary calculation program described in any of Aspects 5 to 7, the following effect is brought about: the policy line corresponding to a staff member's rating is acquired. As a result, a disparity in the basic salary can be provided between ratings. Further, the standard salary increase rate based on the policy line corresponding to a relevant rating is acquired. As a result, the increased basic salary at an identical rating is an amount approximate to the policy line at the rating. Therefore, the following effect is brought about: a disparity in basic salary between staff members belonging to an identical rating can be suppressed.

In addition, when a rating is incorporated into the standard salary increase rate, an influence of the height of rating on the total salary increase rate can be made independent of the basic salary position as compared with when the rating is incorporated into the positional salary increase rate corresponding to the basic salary position. As a result, the following effect is also brought about: the height of the rating can be incorporated into the increased basic salary.

According to the basic salary calculation program described in Aspect 9, in addition to the effect brought about by the basic salary calculation program described in any of Aspects 1 to 8, the following effect is brought about: since the positional salary increase rate is calculated according to the basic salary position and a staff member′ evaluation, the following effect is brought about: the fruit from the staff member's job can be incorporated into the positional salary increase rate and the total salary increase rate calculated from the positional salary increase rate.

According to the basic salary calculation program described in Aspect 10, in addition to the effect brought about by the basic salary calculation program described in any of Aspects 1 to 9, the following effect is brought about: the policy line corresponding to a staff member's rating is acquired. These bring about the effect of the capability to suppress a disparity in the basic salary between staff members. Further, the following effect is brought about by incorporating a rating into the positional salary increase rate: a disparity due to the height of the rating can be incorporated into the increased basic salary.

According to the basic salary calculation program described in Aspect 11, in addition to the effect brought about by the basic salary calculation program described in Aspect 8 or 10, the following effect is brought about: the increased basic salary corresponding to a number of continuance years set for each rating is calculated and a transition thereof is acquired. As a result, the following effect is brought about: a transition of the basic salary can be easily and swiftly acquired without referring to a pay scale.

### BRIEF DESCRIPTION OF THE DRAWINGS

FIG. 1 is a block diagram illustrating an electrical configuration of PC.

FIG. 2A is a drawing schematically showing a basic salary information table. FIG. 2B is a graph indicating a transition of the positional salary increase rate.

FIG. 3A is a drawing schematically showing a staff member information table. FIG. 3B is a drawing schematically showing a number of continuance years table.

FIG. 4 is a flowchart of main processing.

FIG. 5A is a flowchart of basic salary calculation processing. FIG. 5B is a flowchart of salary increase amount calculation processing.

FIG. 6 is a schematic diagram explaining the basic salary position and the increased basic salary.

FIG. 7 is a flowchart of basic salary transition calculation processing.

FIG. 8 is a drawing representing a transition of the basic salary.

FIG. 9A is a graph indicating a transition of the positional salary increase rate made when a quadratic function is used as the enumeration function for positional salary increase rate in a modification.

FIG. 9B is a graph indicating a transition of the positional salary increase rate made when a cubic function is used as the enumeration function for the positional salary increase rate in a modification.

FIG. 10A is a graph indicating a transition of the total salary increase rate made when a linear function is used as the enumeration function for the total salary increase rate in a modification. FIG. 10B is a graph indicating a transition of the total salary increase rate made when a quadratic function is used as the enumeration function for the total salary increase rate in a modification. FIG. 10C is a graph indicating a transition of the total salary increase rate made when a cubic function is used as the enumeration function for the total salary increase rate in a modification.

### DESCRIPTION OF EXEMPLARY EMBODIMENTS

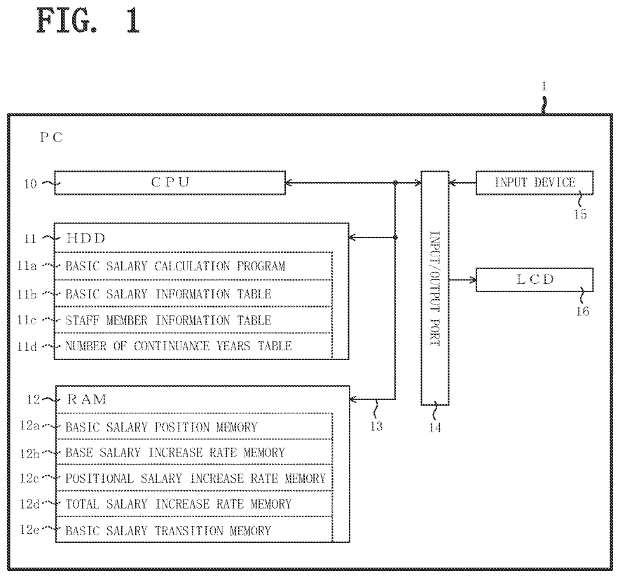

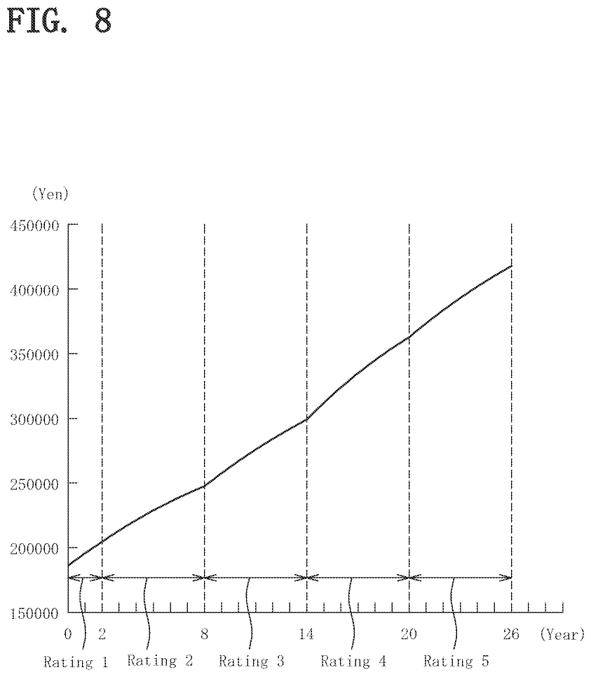

Hereafter, a description will be given to preferred embodiments of the present invention with reference to the accompanying drawings. First, a description will be given to a personal computer 1 (hereafter, abbreviated as “PC 1”) with reference to FIGS. 1 to 3. FIG. 1 is a block diagram illustrating an electrical configuration of the PC 1. The PC 1 is an information processing apparatus (computer) that calculates an increased basic salary Xn, which is the increased basic salary of an one staff member, and a transition of a future basic salary (Refer to FIG. 8) from the previous basic salary Xb, which is the previous basic salary of the one staff member, a lower limit amount A, an upper limit amount B, and a policy line C of the basic salary, and the like.

As shown in FIG. 1, the PC 1 includes the CPU 10, a hard disk drive 11 (hereafter, abbreviated as “HDD 11”), and RAM 12 and these components are respectively connected to an input/output port 14 via a bus line 13. The input/output port 14 is further connected with: an input device 15 for inputting instructions from a user and varied information; and LCD 16 for displaying the calculated increased basic salary Xn, a transition of a future basic salary; and the like.

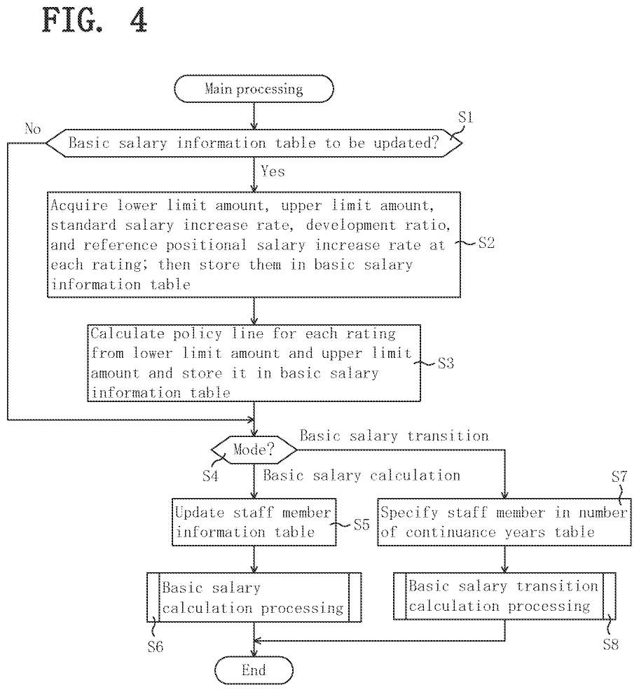

The CPU 10 is an arithmetic unit that controls each part connected via the bus line 13. The HDD 11 is a rewritable nonvolatile storage device that holds programs executed by the CPU 10, fixed value data, and the like and accommodates a basic salary calculation program 11a, a basic salary information table lib, a staff member information table 11c, and a number of continuance years table 11d. When the basic salary calculation program 11a is executed by the CPU 10, the main processing in FIG. 4 is performed.

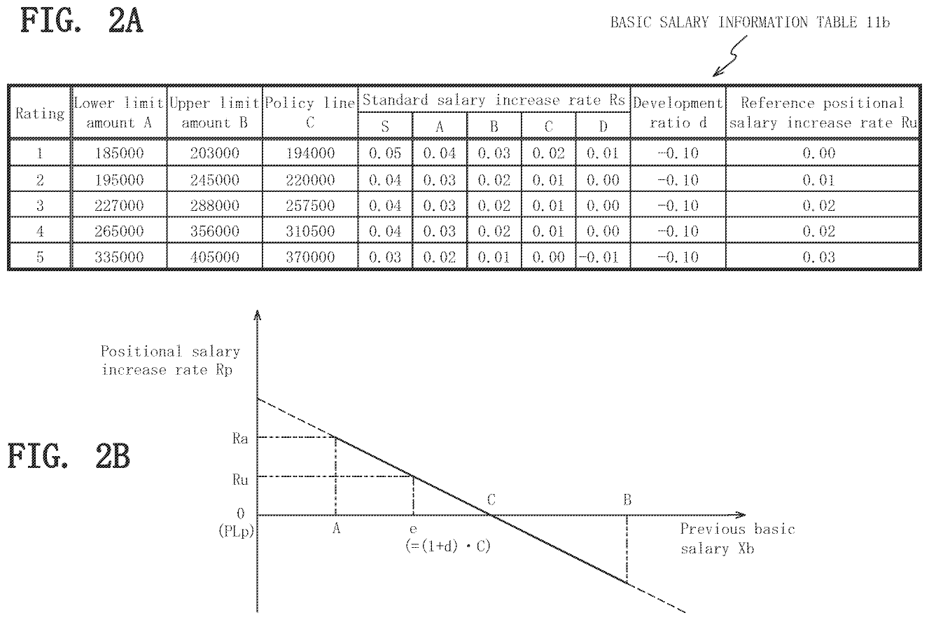

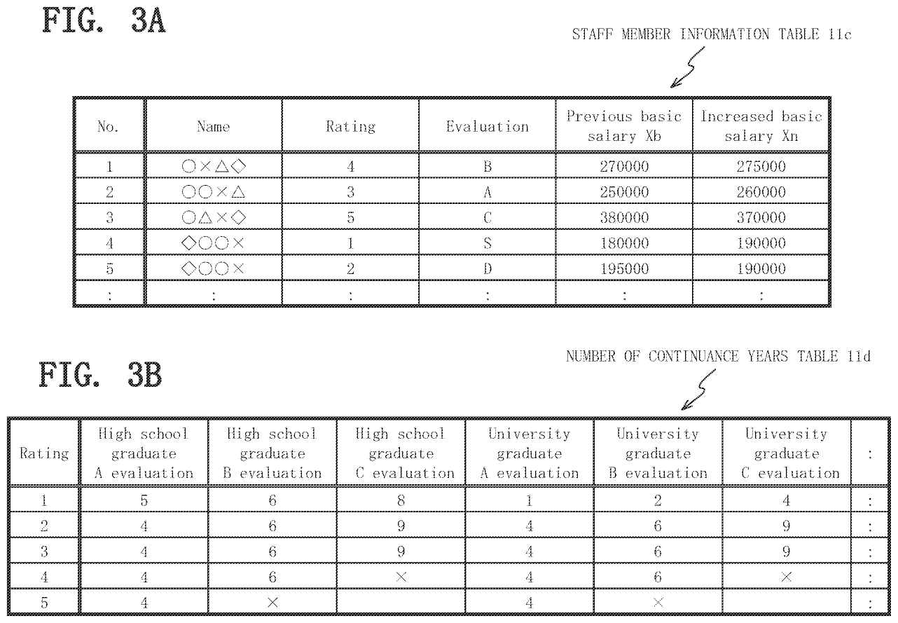

The basic salary information table 11b is a data table that stores information about the basic salary; and the staff member information table 11c is the data table that stores information about the basic salary of each staff member. The number of continuance years table 11d is the data table in which a number of continuance years for each rating obtained when a staff member having a predetermined educational background (high school graduate, university graduate, and the like) continuously gains a predetermined evaluation is set. A description will be given to each of the basic salary information table lib, the staff member information table 11c, and the number of continuance years table 11d with reference to FIGS. 2 and 3.

FIG. 2A is a drawing schematically showing the basic salary information table lib. The basic salary information table 11b stores a lower limit amount A, the upper limit amount B, the policy line C, a standard salary increase rate Rs, a development ratio d, and a reference positional salary increase rate Ru for each rating indicating a managerial position of the staff member. In the present embodiment, a rating is provided in five stages, “rating 1” to “rating 5” and a larger value represents a higher managerial position.

For the standard salary increase rate Rs, a total salary increase rate R at the policy line C is set for each evaluation of staff members. In the present embodiment, an evaluation is set according to the situation of a staff member's job and a fruit therefrom and five stages, “S,” “A,” “B,” “C,” and “D,” are set in the descending order of evaluation. For standard salary increase rate Rs, the total salary increase rate R obtained when a previous basic salary Xb is at the policy line C at each evaluation is set.

In the present embodiment, the increased basic salary Xn is calculated by adding the previous basic salary Xb to a salary increase amount Dn calculated by multiplying the previous basic salary Xb by the total salary increase rate R. The total salary increase rate R is calculated by adding a base salary increase rate Rbs based on the above-mentioned standard salary increase rate Rs and a positional salary increase rate Rp corresponding to a basic salary position Pr, which is a difference between the previous basic salary Xb and the policy line C. The details of base salary increase rate Rbs and the positional salary increase rate Rp will be described later.

A development ratio d is a ratio representing an amount of deviation (amount) between a reference position basic salary e which is a predetermined previous basic salary Xb and the policy line C, used for setting the enumeration function for calculating the positional salary increase rate Rp. The reference positional salary increase rate Ru is the positional salary increase rate Rp at the reference position basic salary e. A description will be given to development ratio d, the reference position basic salary e, reference the positional salary increase rate Ru, and the positional salary increase rate Rp with reference to FIG. 2.

FIG. 2B is a graph indicating a transition of the positional salary increase rate Rp. In the present embodiment, the positional salary increase rate Rp is calculated from the enumeration function as a linear function using the previous basic salary Xb as input. A description will be given to setting of the enumeration function for such the positional salary increase rate Rp. In the present embodiment, when the previous basic salary Xb is at the policy line C, the positional salary increase rate Rp is set to 0. Hereafter, such the positional salary increase rate Rp at the policy line C will be referred to as “PL positional salary increase rate PLp.” For the PL positional salary increase rate PLp, 0 is not always set and a value equal to more than 0 may be set or a value equal to or less than 0 may be set.

What is used for setting the enumeration function together with the PL positional salary increase rate PLp at the policy line C is the reference position basic salary e based on a development ratio d in the basic salary information table 11b and the reference positional salary increase rate Ru. Specifically, a reference position basic salary e is an amount deviating from the policy line C by an amount corresponding to the development ratio d and is calculated by Numerical Expression 1.

e=(1+d)·C (Numerical Expression 1)

For example, when the policy line C is “220,000” and the development ratio d is “−0.10,” the reference position basic salary e is “198,000.” In the present embodiment, the development ratio d is so set that the reference position basic salary e is an amount between the lower limit amount A and the upper limit amount B.

The enumeration function for the positional salary increase rate Rp is expressed as represented by Numerical Expression 2 as a linear function running through the PL positional salary increase rate PLp (that is, 0) obtained when the previous basic salary Xb is at the policy line C and the reference positional salary increase rate Ru obtained when the previous basic salary Xb is equal to the reference position basic salary e.

$$Rp = \frac{Ru}{C \cdot d} ( Xb - C ) = \frac{Ru}{C \cdot d} \cdot Pr \qquad ( Numerical Expression 2 )$$

As indicated by Numerical Expression 2, the positional salary increase rate Rp is a ratio corresponding to a difference between the previous basic salary Xb and the policy line C. Since a difference between the previous basic salary Xb and the policy line C is equal to the above-mentioned basic salary position Pr, the positional salary increase rate Rp is a ratio corresponding to the basic salary position Pr.

In the present embodiment, in the basic salary information table 11b in FIG. 2A, a ratio equal to or less than 0 is set for development ratio d and the positional salary increase rate Rp equal to or more than 0 is set for the reference positional salary increase rate Ru. Therefore, when the previous basic salary Xb is less than the policy line C, the positional salary increase rate Rp is equal to or more than the PL positional salary increase rate PLp. Meanwhile, when the previous basic salary Xb is more than the policy line C, the positional salary increase rate Rp is equal to or less than the PL positional salary increase rate PLp.

The present invention is not limited to a configuration in which in the basic salary information table 11b in FIG. 2A, a value equal to or less than 0 is set for development ratio d and the positional salary increase rate Rp equal to or more than 0 is set for the reference positional salary increase rate Ru. For example, a value equal to or more than 0 may be set for development ratio d and the positional salary increase rate Rp equal to or less than 0 may be set for the reference positional salary increase rate Ru.

In Numerical Expression 2, the term in which the reference positional salary increase rate Ru is divided by a multiplied value of the policy line C and the development ratio d is equivalent to a “gradient” of the enumeration function as a linear function. A development ratio d is a value for setting how much the reference position basic salary e should be away from the policy line C. The reference positional salary increase rate Ru is a value for setting how much should be added to or subtracted from the PL positional salary increase rate PLp at the reference position basic salary e. When such the development ratio d or the reference positional salary increase rate Ru is set according to performance, salary increase capital, a result of labor-management negotiation, or the like, the positional salary increase rate Rp in magnitude matched with these items can be given.

Especially, like “rating 1” in FIG. 2A, when “0.00” is set for the reference positional salary increase rate Ru, a positional salary increase rate Rp is “0.00” by Numerical Expression 2. As a result, an influence of the positional salary increase rate Rp, that is, the basic salary position Pr can be eliminated from the total salary increase rate R.

The reference position basic salary e is calculated from the development ratio d and the policy line C. When the development ratio d is fixed, a relative positional relation between the policy line C and the reference position basic salary e in terms of amount can be made constant even though the policy line C is varied. When such a relative positional relation is grasped and then the reference positional salary increase rate Ru at the reference position basic salary e according to the development ratio d is set, the magnitude of the positional salary increase rate Rp can be easily set.

A description will be given to the staff member information table 11c and the number of continuance years table 11d with reference to FIGS. 3A and 3B. FIG. 3A is a drawing schematically showing the staff member information table 11c and FIG. 3B is a drawing schematically showing the number of continuance years table 11d. As shown in FIG. 3A, the staff member information table 11c stores a staff member's name, the above-mentioned rating and evaluation, the previous basic salary Xb, and the increased basic salary Xn in the order of staff member number (“No.” in FIG. 3A).

As shown in FIG. 3B, a plurality of “model” staff members are assumed according to an educational background and an evaluation the staff members continuously gain. The number of continuance years table 11f stores a number of continuance years for each rating on such a staff member-by-staff member basis. This is because a number of continuance years for each rating differs depending on an educational background or an evaluation the relevant staff member continuously gains. For example, in FIG. 3B, for a number of continuance years of a model staff member whose educational background is “high school graduate” and continuously gaining evaluation is “A,” five years is set for rating 1; four years is set for rating 2; four years is set for rating 3, four years is set for rating 4; and four years is set for rating 5. In FIG. 3B, “x” indicates that a staff member stays at the subsequent relevant rating. A transition of a future basic salary is calculated according to a number of continuance years stored in the number of continuance years table 11d.

The description will be back to FIG. 1. The RAM 12 is a memory for CPU 10 to rewritably store varied work data, a flag, and the like when executing the basic salary calculation program 11a. The RAM is provided with: a basic salary position memory 12a storing the basic salary position Pr; a base salary increase rate memory 12b storing a base salary increase rate Rbs; a positional salary increase rate memory 12c storing the positional salary increase rate Rp; a total salary increase rate memory 12d storing the total salary increase rate R; and a basic salary transition memory 12e storing a transition of the basic salary in chronological order.

A description will be given to main processing performed at CPU 10 of PC 1 with reference to FIG. 4 to FIG. 8. FIG. 4 is a flowchart of the main processing. The main processing is performed when an instruction to execute the basic salary calculation program 11a is provided from the input device 15.

First, the main processing confirms whether to update the basic salary information table 11b (S1). When the basic salary information table 11b is to be updated (S1: Yes), the lower limit amount A, the upper limit amount B, the standard salary increase rate Rs, the development ratio d, and the reference positional salary increase rate Ru for each rating are individually acquired from the input device 15 and are respectively stored in a corresponding area in the basic salary information table 11b (S2).

After the processing of S2, the policy line C for each rating is calculated from the acquired lower limit amount A and upper limit amount B and is stored in the corresponding area in the basic salary information table 11b (S3). The policy line C is an amount between the lower limit amount A and the upper limit amount B and in the present embodiment, a value obtained by dividing a sum of the lower limit amount A and the upper limit amount B by 2, that is, an average value between the lower limit amount A and the upper limit amount B is set as the policy line C.

When the basic salary information table 11b is determined not to be updated in the processing of S1 (S1: No), the processing of S2 and S3 is skipped.

After the processing of S1 and S3, a computing mode is confirmed (S4). In the present embodiment, as computing mode, a “Basic salary calculation mode” of calculating the increased basic salary Xn and a “Basic salary transition mode” of calculating and displaying the transition of the future basic salary are provided. In the processing of S4, which mode of these computing modes should be used is determined based on input from the input device 15.

When it is determined in the processing of S4 that the computing mode is the “Basic salary calculation mode” (S4: Basic salary calculation), the staff member information table 11c is updated (S5). Specifically, a rating and an evaluation inputted from the input device are stored in the staff member information table 11c and a value of the increased basic salary Xn calculated in the previous processing is stored as the previous basic salary Xb in preparation for basic salary calculation processing of S6 described later. When a new employee by new graduation or mid-carrier recruitment is added to the staff member information table 11c, an amount equivalent to the basic salary as a starting salary is stored together with the new employee's name, rating, and evaluation in the previous basic salary Xb. After the processing of S5, the basic salary calculation processing is performed (S6).

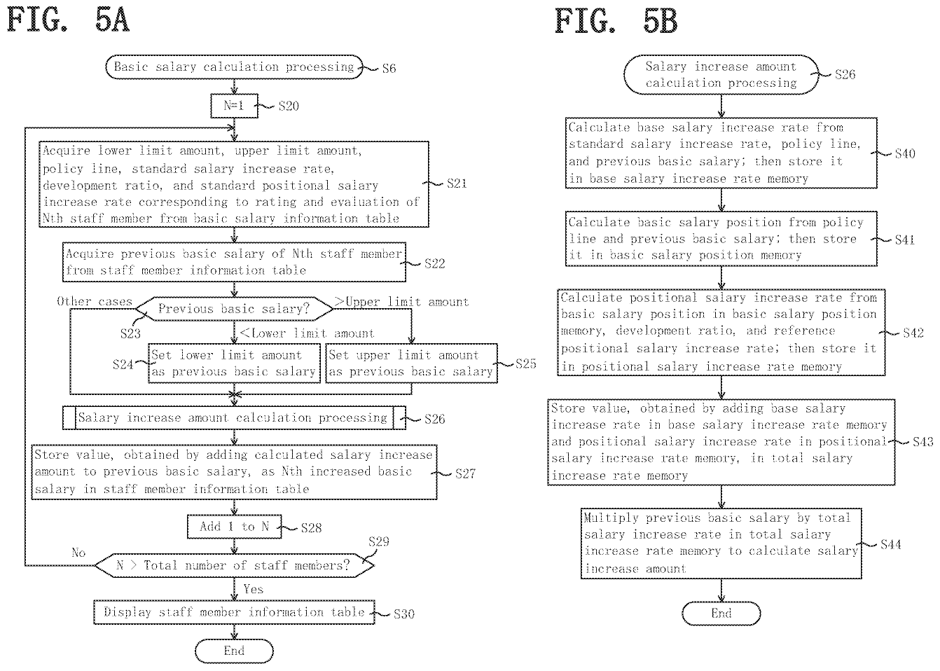

A description will be given to the basic salary calculation processing with reference to FIG. 5A. FIG. is a flowchart of the basic salary calculation processing. The basic salary calculation processing is processing of calculating the increased basic salary Xn from the previous basic salary Xb, the lower limit amount A, the upper limit amount B, and the policy line C of the basic salary, and the like.

In the basic salary calculation processing, first, a counter variable N representing a staff member number is set to 1 (S20). After the processing of S20, a rating and an evaluation of a staff member corresponding to the Nth staff member number are acquired from the staff member information table 11c. Then, the lower limit amount A, the upper limit amount B, the policy line C, the standard salary increase rate Rs, the development ratio d, and the reference positional salary increase rate Ru corresponding to the acquired rating and evaluation are acquired from the basic salary information table 11b (S21). After the processing of S21, an evaluation and the previous basic salary Xb of the Nth staff member are acquired from the staff member information table 11c (S22).

After the processing of S22, the amount of the previous basic salary Xb is confirmed (S23). When at S23, the previous basic salary Xb is less than the lower limit amount A (S23: “<Lower limit amount”), the lower limit amount A is set as the previous basic salary Xb (S24). When at S23, the previous basic salary Xb is more than the upper limit amount B (S23: “>Upper limit amount”, the upper limit amount B is set as the previous basic salary Xb (S25). As a result, when the previous basic salary Xb becomes less than the lower limit amount A as the result of promotion, wage raise, or the like, the previous basic salary Xb is corrected to the lower limit amount A. When the previous basic salary Xb becomes more than the upper limit amount B as the result of demotion, base-down, or the like, the previous basic salary Xb is corrected to the upper limit amount B.

Meanwhile, when at the processing of S23, the previous basic salary Xb is equal to or more than the lower limit amount A and is equal to or less than the upper limit amount B (S23: “Other cases”), the processing of S24 and S25 is skipped. After the processing of S23 to S25, salary increase amount calculation processing is performed (S26).

A description will be given to the salary increase amount calculation processing with reference to FIG. 5B. FIG. 5B is a flowchart of the salary increase amount calculation processing. The salary increase amount calculation processing is processing of: calculating the above-mentioned base salary increase rate Rbs and the positional salary increase rate Rp; calculating the total salary increase rate R from these increase rates; and using the total salary increase rate R to calculate the salary increase amount Dn.

In the salary increase amount calculation processing, first, a base salary increase rate Rbs is calculated from the acquired standard salary increase rate Rs, the policy line C, and the previous basic salary Xb and is stored in the base salary increase rate memory 12b (S40). Specifically, the base salary increase rate Rbs is calculated by Numerical Expression 3.

$$Rbs = \frac{Rs \cdot C}{Xb} \qquad ( Numerical Expression 3 )$$

That is, a value obtained by dividing a value, obtained by multiplying the standard salary increase rate Rs by the policy line C, by the previous basic salary Xb is taken as base salary increase rate Rbs and is stored in the base salary increase rate memory 12b.

After the processing of S40, the basic salary position Pr is calculated from the previous basic salary Xb and the policy line C and is stored in the basic salary position memory 12a (S41). Specifically, a value obtained by subtracting the policy line C from the previous basic salary Xb is taken as basic salary position Pr and is stored in the basic salary position memory 12a.

After the processing of S41, the positional salary increase rate Rp is calculated by Numerical Expression 2 from the basic salary position Pr and the acquired development ratio d and the reference positional salary increase rate Ru and is stored in the positional salary increase rate memory 12c (S42).

After the processing of S42, the total salary increase rate R is calculated by adding the base salary increase rate Rbs in the base salary increase rate memory 12b and the positional salary increase rate Rp in the positional salary increase rate memory 12c and is stored in the total salary increase rate memory 12d (S43).

After the processing of S43, the previous basic salary Xb is multiplied by the total salary increase rate R in the total salary increase rate memory 12d to calculate the salary increase amount Dn (S44) and the salary increase amount calculation processing is terminated.

The description will be back to FIG. 5A. After the salary increase amount calculation processing of S26, the salary increase amount Dn calculated by the processing of S44 in FIG. 5B is added to the previous basic salary Xb to calculate the increased basic salary Xn, which is stored in the increased basic salary Xn of the Nth staff member in the staff member information table 11c (S27).

At this time, the calculated increased basic salary Xn is rounded. In the present embodiment, an amount obtained by subjecting a value obtained by multiplying the previous basic salary Xb by the total salary increase rate R to “round-off between 3 and 4” of the unit of 10 yen is set as the increased basic salary Xn. (In this round-off, for example, when an amount at the unit of 10 yen or below is “39 yen” or below, the amount is rounded down and when the amount is “40 yen” or above, the amount is rounded up.) The round-off of the increased basic salary Xn is not limited to “round-off between 3 and 4” and any other round-off, such as “round-off between 4 and 5,” may be applied. The target of round-off is not limited to the unit of 10 yen and any other numeric digit, such as the unit of 100 yen, may be targeted.

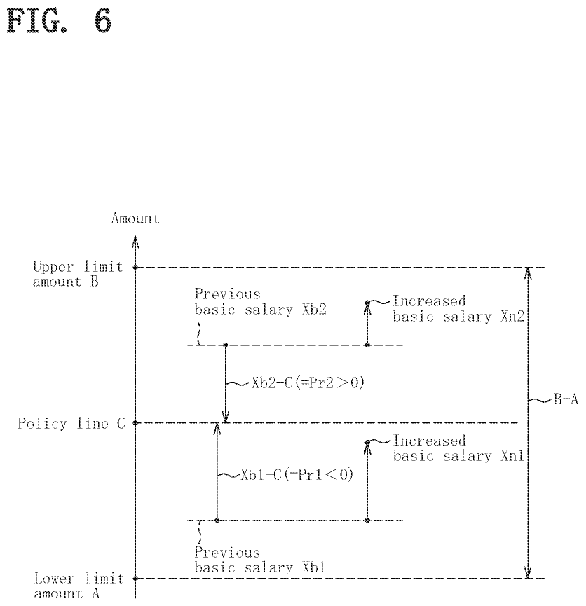

The increased basic salary Xn is an amount obtained by adding the salary increase amount Dn to the previous basic salary Xb, and the salary increase amount Dn is an amount obtained by multiplying the previous basic salary Xb by the total salary increase rate R. The total salary increase rate R is the salary increase rate obtained by adding the positional salary increase rate Rp to the base salary increase rate Rbs. A description will be given to an influence of the positional salary increase rate Rp on the total salary increase rate R with reference to FIG. 6.

FIG. 6 is a schematic diagram explaining basic salary position Pr and the increased basic salary Xn. In FIG. 6, the vertical axis indicates an amount and represents the lower limit amount A, the upper limit amount B, and an amount of the policy line C. In FIG. 6, the previous basic salary Xb1 that is an amount less than the policy line C and the previous basic salary Xb2 that is an amount more than the policy line C are represented as the previous basic salary Xb.

As shown in FIG. 6, a basic salary position Pr1, which is a difference between the previous basic salary Xb1 and the policy line C, is less than 0 and a basic salary position Pr2, which is a difference between the previous basic salary Xb2 and the policy line C, is more than 0. By such basic salary positions Pr1, Pr2 and the enumeration function in Numerical Expression 2, positional salary increase rates Rp1, Rp2 are calculated and increased basic salaries Xn1, Xn2 are calculated. It is assumed that base salary increase rates Rbs1, Rbs2 used for calculation of increased basic salaries Xn1, Xn2 are given an identical value.

Therefore, as indicated in FIG. 6, the previous basic salary Xb1 is given the high positional salary increase rate Rp1 based on the low basic salary position Pr1. As a result, the increased basic salary Xn1 can be significantly increased from the previous basic salary Xb1 less than the policy line C. Meanwhile, the previous basic salary Xb2 is given the low positional salary increase rate Rp2 based on a high basic salary position Pr2. As a result, an increased basic salary Xn2 is suppressed from being increased from the previous basic salary Xb2 more than the policy line C. Because of the foregoing, a disparity in basic salary can be suppressed between staff members.

With respect to the total salary increase rate R, the base salary increase rate Rbs is added to such the positional salary increase rate Rp. As mentioned above, the base salary increase rate Rbs is calculated from the standard salary increase rate Rs, the policy line C, and the previous basic salary Xb. Of these items, the standard salary increase rate Rs is the total salary increase rate R at the policy line C; therefore, the standard salary increase rate Rs can be taken as the “standard level” of the total salary increase rate R.

As shown in FIG. 2A, in the basic salary information table lib, the policy line C and the standard salary increase rate Rs are set for each rating and evaluation and the policy line C and the standard salary increase rate Rs corresponding to a staff member's rating and evaluation are acquired. As a result, the increased basic salary Xn at an identical rating is an amount approximate to the policy line C at that rating; therefore, a disparity in the basic salary can be suppressed between staff members belonging to an identical rating. Further, since the standard salary increase rate Rs is the salary increase rate also corresponding to a staff member's evaluation, a fruit from a staff member's job can be incorporated into the total salary increase rate R.

As the result of a rating and an evaluation being incorporated into the standard salary increase rate Rs, an influence of the magnitude of a rating and the magnitude of an evaluation on the total salary increase rate R can be made more independent of the basic salary position Pr as compared with cases where they are incorporated into the positional salary increase rate Rp corresponding to the basic salary position Pr. As a result, the magnitude of a rating can be appropriately incorporated into a salary increase amount D and the increased basic salary Xn.

As represented by Numerical Expression 3, the base salary increase rate Rbs is a value obtained by dividing a multiplied value, obtained by multiplying the standard salary increase rate Rs by the policy line C, by the previous basic salary Xb. Consequently, an amount (hereafter, referred to as “base amount”) equivalent to the base salary increase rate Rbs of the salary increase amount Dn is an amount obtained by multiplying the base salary increase rate Rbs by the previous basic salary Xb, that is, an amount obtained by multiplying the standard salary increase rate Rs by the policy line C. Since such a base amount does not depend on a fluctuating basic salary position Pr or the previous basic salary Xb, the base amount can be taken as the “standard level” of the basic salary. Therefore, when the standard salary increase rate Rs or the policy line C is varied according to performance, salary increase capital, a result of labor-management negotiation, or the like, the standard level of the basic salary can be flexibly varied according to these items.

Further, by grasping a base amount, an amount equivalent to the positional salary increase rate Rp of the salary increase amount Dn can be grasped. As a result, how much the salary increase amount Dn was added or subtracted according to the positional salary increase rate Rp, that is, the basic salary position Pr can be easily grasped.

The description will be back to FIG. 5A. After the processing of S27, 1 is added to the counter variable N (S28) and it is confirmed whether the incremented counter variable N has been larger than a total number of staff members, that is, a number of staff members stored in the staff member information table 11c (S29). When the counter variable N is equal to or smaller than the total number of staff members in the processing of S29 (S29: No), the processing of S21 and the following steps is repeated. Meanwhile, when the counter variable N is larger than the total number of staff members (S29: Yes), the contents of the staff member information table 11c are displayed in LCD 16 (S30). After the processing of S30, the basic salary calculation processing is terminated and the control returns to the main processing in FIG. 4.

When the computing mode is “Basic salary transition mode” in the processing of S4 in FIG. 4 (S4: Basic salary transition), any staff member of the model staff members stored in the number of continuance years table 11d should be used is specified to calculate a transition of the basic salary (S7). Hereafter, a staff member specified in the processing of S7 will be referred to as “specified staff member.” After the processing of S7, basic salary transition calculation processing is performed (S8).

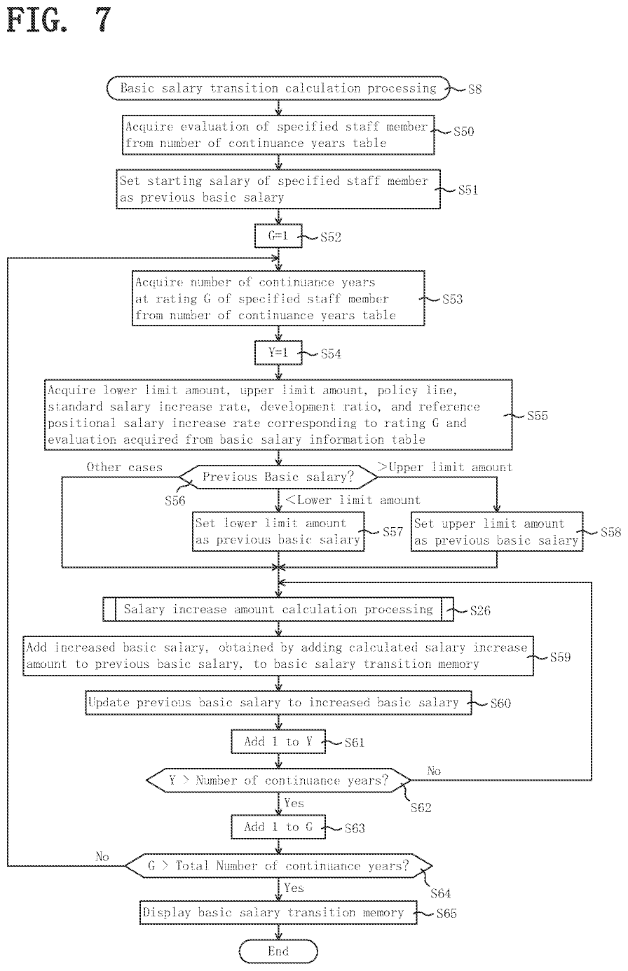

A description will be given to the basic salary transition calculation processing with reference to FIG. 7. FIG. 7 is a flowchart of the basic salary transition calculation processing. In the basic salary transition calculation processing, first, an evaluation of a specified staff member in the number of continuance years table 11d is acquired (S50). After the processing of S50, the basic salary of a starting salary of the specified staff member is set as an initial value of the previous basic salary Xb (S51). For the basic salary of the starting salary, a different amount may be set between high school graduate and university graduate or an identical amount may be set.

After the processing of S51, 1 is set for counter variable G representing a rating (S52), and a number of continuance years at the rating G of the specified staff member is acquired from the number of continuance years table 11d (S53). After the processing of S53, 1 is set for counter variable Y representing a number of years (S54). After the processing of S54, the lower limit amount A, the upper limit amount B, the policy line C, the standard salary increase rate Rs, the development ratio d, and the reference positional salary increase rate Ru corresponding to the rating G and the evaluation acquired by the processing of S50 are acquired from the basic salary information table 11b (S55).

After the processing of S55, the amount of the previous basic salary Xb is confirmed (S56). When at S56, the previous basic salary Xb is less than the lower limit amount A (S56: “<Lower limit amount”), the lower limit amount A is set as previous basic salary Xb (S57). When at S56, the previous basic salary Xb is more than the upper limit amount B (S56: “>Upper limit amount”), the upper limit amount B is set as the previous basic salary Xb (S58). When at S56, the previous basic salary Xb is equal to or more than the lower limit amount A and equal to or less than the upper limit amount B (S56: “Other cases”), the processing of S57 and S58 is skipped.

After the processing of S56 to S58, the above-mentioned salary increase amount calculation processing at S26 in FIG. 5B is performed. Thereafter, the salary increase amount Dn calculated by the processing of S44 in FIG. 5B is added to the previous basic salary Xb to calculate the increased basic salary Xn, which is added to the basic salary transition memory 12e (S59). As a result, the basic salary for a number of years Y at the rating G is added to the basic salary transition memory 12e. The increased basic salary Xn calculated by the processing of S59 is also subjected to the same round-off as the processing of S27 in FIG. 5A.

After the processing of S59, the previous basic salary Xb is updated to the increased basic salary Xn (S60). After the processing of S60, 1 is added to the counter variable Y (S61) and it is confirmed whether the incremented counter variable Y is larger than the number of continuance years acquired by the processing of S53 (S62). When in the processing of S62, the counter variable Y is equal to or smaller the number of continuance years (S62: No), a basic salary equivalent to a number of continuance years set for the rating G has not been calculated yet and thus, the processing of S26 and the following steps is repeated. Meanwhile, when in the processing of S62, the counter variable Y is larger than the number of continuance years (S62: Yes), calculation of the basic salary equivalent to the number of continuance years set for the rating G has been completed. Therefore, 1 is added to the counter variable G for calculating the basic salary for the next rating G (S63).

After the processing of S63, it is confirmed whether the counter variable G is larger than a total number of ratings (that is, “5”) (S64). When in the processing of S64, the counter variable G is smaller than the total number of ratings (S64: No), a rating G for which the basic salary has not been calculated yet is present and thus, the processing of S53 and the following steps is performed. Meanwhile, when the counter variable G is larger than the total number of ratings (S64: Yes), calculation of the basic salary has been completed for all the ratings G. Therefore, a transition of the basic salary in the basic salary transition memory 12e is displayed in LCD 16 (S65) and the basic salary transition calculation processing is terminated.

FIG. 8 shows an example of a transition of the basic salary acquired in the “Basic salary transition mode” of this basic salary calculation program 11a. FIG. 8 is a drawing representing a transition of the basic salary. FIG. 8 illustrates a case where the educational background is university graduate, B evaluation is continuously gained, and the previous basic salary Xb immediately before each rating is switched is an amount between the lower limit amount A and the upper limit amount B after a rating is switched.

As shown in FIG. 8, even when a rating is switched from rating 1 to rating 2, from rating 2 to rating 3, and so on, the increased basic salary Xn undergoes a smooth transition. This is because the increased basic salary Xn immediately after a rating is switched is also calculated based on the previous basic salary Xb before a rating is switched by the processing of S56 to S58 and S60. As a result, even when a rating is switched, steep increase/decrease in the increased basic salary Xn can be suppressed.

A specific description will be given. In case of promotion, when the previous basic salary Xb before the promotion is less than the lower limit amount A at a rating after the promotion, the previous basic salary Xb set to that lower limit amount A (S57). In case of demotion, meanwhile, when the previous basic salary Xb before the demotion is more than the upper limit amount B at a rating after the demotion, the previous basic salary Xb is set to that upper limit amount B (S58). That is, when the previous basic salary Xb is not equal to an amount between the lower limit amount A and the upper limit amount B after a rating is switched, a correction is made to whichever is closer, the lower limit amount A or the upper limit amount B, and then the increased basic salary Xn is calculated. As a result, a difference between the previous basic salary Xb before correction and the increased basic salary Xn is suppressed to the minimum. Therefore, even in this case, steep increase/decrease in the increased basic salary Xn can be suppressed.

When such a transition of the basic salary is acquired based on a pay scale, the basic salary corresponding to a number of continuance years need be acquired from the pay scale one by one. Further, when a rating is switched, the basic salary corresponding to the previous basic salary Xb before the rating is switched need be acquired from the pay scale after the rating is switched. In cases where the basic salary corresponding to the previous basic salary Xb is not present in the pay scale after a rating is switched at this time, the basic salary approximate to the previous basic salary Xb must be searched for from the pay scale. Therefore, when a transition of the basic salary is created from a pay scale, a procedure therefor is intricate.

In the present embodiment, meanwhile, a transition of the basic salary with switching of a rating taken into account can be calculated just by setting an educational background, an evaluation continuously gained, and a number of continuance years for each rating in the number of continuance years table 11d in advance. As a result, a transition of the basic salary can be easily and swiftly acquired.

The description will be back to FIG. 4. After the basic salary calculation processing of S7 or the basic salary transition calculation processing of S8, the main processing is terminated.

Up to this point, a description has been given to the present invention based on the embodiment but the present invention is not limited to the above-mentioned embodiment at all. It is easily inferred that the present invention can be variously improved or modified without departing from the subject matter of the present invention.

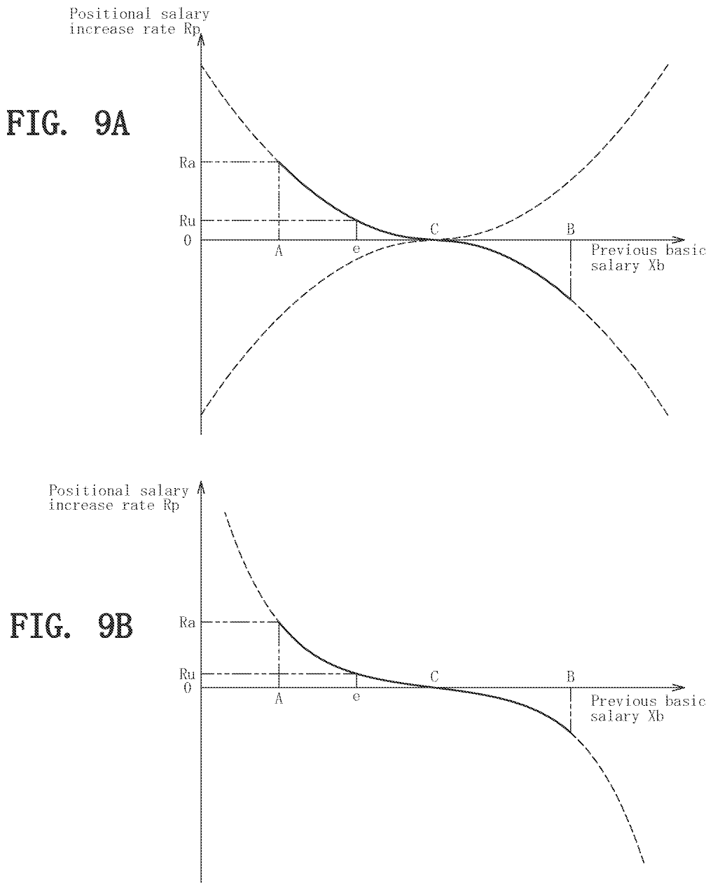

In the above-mentioned embodiment, a linear function is used as the enumeration function for the positional salary increase rate Rp but the present invention is not limited to this. For example, as shown in FIG. 9A, a quadratic function may be used as the enumeration function for the positional salary increase rate Rp. In this case, the enumeration function is Numerical Expression 4.

$$\{ \begin{matrix}Rp = \frac{Ru}{{C}^{2} {d}^{2}} \cdot {( Xb - C )}^{2} ⋯ ( When Xb \leq C ) \\ Rp = \text{} - \frac{Ru}{{C}^{2} {d}^{2}} \cdot {( Xb - C )}^{2} ⋯ ( When Xb > C )\end{matrix} \qquad ( Numerical Expression 4 )$$

As shown in FIG. 9B, a cubic function may be used as the enumeration function for the positional salary increase rate Rp. In this case, the enumeration function is Numerical Expression 5.

$$Rp = \frac{Ru}{{C}^{3} {d}^{3}} \cdot {( Xb - C )}^{3} \qquad ( Numerical Expression 5 )$$

The enumeration function is not limited to linear function, quadratic function, or cubic function and may be quartic function or quintic function or may be any other function, such as exponential function, logarithmic function, or trigonometric function.

In the above-mentioned embodiment, a reference position basic salary e used for setting the enumeration function for the positional salary increase rate Rp is calculated from the development ratio d but the present invention is not limited to this. A reference position basic salary e may be set in advance and instead of the development ratio d, the set reference position basic salary e may be stored in the basic salary information table 11b. This reference position basic salary e may be used for setting the enumeration function for the positional salary increase rate Rp. At this time, the lower limit amount A or the upper limit amount B may be set as the reference position basic salary e.

Especially, when the reference position basic salary e is taken as lower limit amount A, Ra could be taken as the positional salary increase rate Rp (that is, the reference positional salary increase rate Ru) at the lower limit amount A. Thus, the enumeration function as linear function for the positional salary increase rate Rp is expressed by Numerical Expression 6; the enumeration function as quadratic function for the positional salary increase rate Rp is expressed by Numerical Expression 7; and the enumeration function as cubic function for the positional salary increase rate Rp is expressed by Numerical Expression 8.

$$( Numerical Expression 6 )$$

$$Rp = \frac{Ra}{A - C} ( Xb - C )$$

$$( Numerical Expression 7 )$$

$$\{ \begin{matrix}Rp = \frac{Ra}{{( A - C )}^{2}} \cdot {( Xb - C )}^{2} ⋯ ( When Xb \leq C ) \\ Rp = - \frac{Ra}{{( A - C )}^{2}} \cdot {( Xb - C )}^{2} ⋯ ( When Xb > C )\end{matrix}$$

$$( Numerical Expression 8 )$$

$$Rp = \frac{Ra}{{( A - C )}^{3}} \cdot {( Xb - C )}^{3}$$

When the lower limit amount A or the upper limit amount B is taken as the reference position basic salary e as mentioned above, a position of the reference position basic salary e in terms of amount can be more easily grasped as compared with cases where the development ratio d is used to set the reference position basic salary e. Therefore, by setting how much the reference positional salary increase rate Ru at an easily graspable lower limit amount A or upper limit amount B should be added to or subtracted from the PL positional salary increase rate PLp, the magnitude of the positional salary increase rate outputted from the enumeration function can be easily set.

The development ratio d is so set that the reference position basic salary e is an amount between the lower limit amount A and the upper limit amount B but the present invention is not limited to this. For example, the development ratio d may be so set that the reference position basic salary e is an amount less than the lower limit amount A or the development ratio d may be so set that the reference position basic salary e is an amount more than the upper limit amount B.

In the above-mentioned embodiment, the total salary increase rate R is obtained by adding the base salary increase rate Rbs and the positional salary increase rate Rp but the present invention is not limited to this. An average value of the base salary increase rate Rbs and the positional salary increase rate Rp may be taken as the total salary increase rate R or may be an amount obtained by multiplying the base salary increase rate Rbs and the positional salary increase rate Rp. Alternatively, the base salary increase rate Rbs and the positional salary increase rate Rp may be respectively multiplied by a predetermined weighting coefficient (for example, 0.2 is used for a weighting coefficient of the base salary increase rate Rbs and 0.8 is used for the weighting coefficient of the positional salary increase rate Rp) and these increase rates may be added.

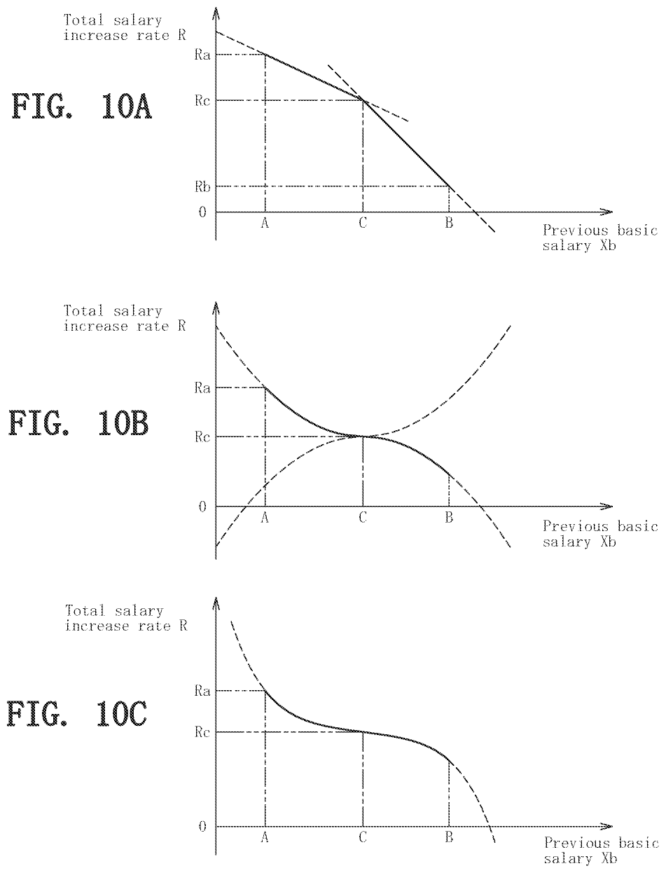

The total salary increase rate R may be configured only of the positional salary increase rate Rp. In this case, as shown in FIG. 10A, a linear function fed with the previous basic salary Xb may be taken as the enumeration function for total salary increase rate R. At this time, the standard salary increase rate Rs is omitted from the basic salary information table 11b (FIG. 2A). Further, with respect to a rating and an evaluation of each staff member, the salary increase rate Ra, which is the total salary increase rate R at the lower limit amount A, the salary increase rate Rc, which is the total salary increase rate R at the policy line C, and the salary increase rate Rb, which is the total salary increase rate R at the upper limit amount B, are stored in the basic salary information table lib. Salary increase rates Ra, Rb, Rc corresponding to a rating and an evaluation of a target staff member are acquired from the basic salary information table lib. The enumeration function for the total salary increase rate R based only on the positional salary increase rate Rp and as a linear function is expressed by Numerical Expression 9 using the acquired salary increase rates Ra, Rb, Rc.

$$( Numerical Expression 9 )$$

$$\{ \begin{matrix}R = \frac{Ra - Rc}{A - C} \cdot ( Xb - A ) + Ra ⋯ ( When Xb \leq C ) \\ R = \text{} \frac{Rc - Rb}{C - B} \cdot ( Xb - C ) + Rc ⋯ ( When Xb > C )\end{matrix}$$

Further, when salary increase rates Ra, Rb, Rc are so set that the increase rates are not located on an identical line in Numerical Expression 9, as shown in FIG. 10A, a gradient of the total salary increase rate R can be made different between cases where the previous basic salary Xb is equal to or less than the policy line and cases where the previous basic salary is more than the policy line C. As a result, a trend of the total salary increase rate R to be given can be made different between cases where the previous basic salary Xb is equal to or less than the policy line and cases where the previous basic salary is more than the policy line C.

When a gradient of the total salary increase rate R is made constant, either of two enumeration functions included in Numerical Expression 9 can be used to calculate the total salary increase rate R. When of the enumeration functions included in Numerical Expression 9, the enumeration function obtained when the previous basic salary Xb is equal to or less than the policy line C is used to calculate the total salary increase rate R, setting of the salary increase rate Rb in the basic salary information table 11b only has to be omitted. Meanwhile, when of the enumeration functions included in Numerical Expression 9, the enumeration function obtained when the previous basic salary Xb is more than the policy line C is used to calculate the total salary increase rate R, setting of the salary increase rate Ra in the basic salary information table 11b only has to be omitted.

Similarly, as shown in FIG. 10B, a quadratic function may be used as the enumeration function for the total salary increase rate R or as shown in FIG. 10C, a cubic function may be used as the enumeration function for the total salary increase rate R. When the quadratic function is used as the enumeration function for the total salary increase rate R, the enumeration function is expressed by Numerical Expression 10 and when the cubic function is used as the enumeration function for the total salary increase rate R, the enumeration function is expressed by Numerical Expression 11.

$$( Numerical Expression 10 )$$

$$\{ \begin{matrix}R = \frac{Ra - Rc}{A - C} \cdot ( Xb - A ) + Ra ⋯ ( When Xb \leq C ) \\ R = \text{} - \frac{Rc - Rb}{C - B} \cdot ( Xb - C ) + Rc ⋯ ( When Xb > C )\end{matrix}$$

$$( Numerical Expression 11 )$$

$$R = \frac{Ra - Rc}{{( A - C )}^{3}} \cdot {( Xb - C )}^{3} + Rc$$

In Numerical Expressions 10, 11, the total salary increase rate R is calculated by one enumeration function regardless of the magnitude of the previous basic salary Xb but the present invention is not limited to this. For example, like Numerical Expression 9 as a linear function, the different enumeration functions may be used to calculate the total salary increase rate R between cases where the previous basic salary Xb is equal to or less than the policy line and cases where the previous basic salary Xb is more than the policy line C.

As mentioned above, when the total salary increase rate R is configured only of the positional salary increase rate Rp, calculation of the base salary increase rate Rbs can be omitted unlike the above-mentioned total salary increase rate R based on the base salary increase rate Rbs and the positional salary increase rate Rp. Therefore, the total salary increase rate R can be easily and swiftly calculated. Further, since salary increase rates Ra, Rb, Rc are set in accordance with a rating and an evaluation of a staff member, a fruit from a staff member's job and the height of a rating can be appropriately incorporated into the total salary increase rate R.

Also, when the total salary increase rate R is configured only of the positional salary increase rate Rp, like the above-mentioned embodiment, a transition of the basic salary may be calculated based on FIGS. 7 and 8. In this case, the following processing can be performed: In the processing of S55 in FIG. 7, the lower limit amount A, the upper limit amount B, the policy line C, and salary increase rates Ra, Rb, Rc corresponding to a rating G and an evaluation are acquired from the basic salary information table 11b; in the processing of S26, the acquired values are used to calculate the total salary increase rate R by any of Numerical Expressions 9 to 11; and the obtained total salary increase rate R is used to calculate the salary increase amount D. In the processing of S59, the calculated salary increase amount D is added to the previous basic salary Xb to calculate the increased basic salary Xn and this increased basic salary Xn is added to the basic salary transition memory 12e.

In the above-mentioned embodiment, an upper limit or the lower limit of a value the total salary increase rate R can take is not set but the present invention is not limited to this. The upper limit (for example, “0.20”) or the lower limit (for example, “0.00” or “0.01”) of a value the total salary increase rate R can take may be set and the calculated total salary increase rate R may be prevented from getting beyond the set upper limit or lower limit. For example, when the lower limit of the total salary increase rate R is set to “0.00” and the calculated total salary increase rate R falls below “0.00” as the result of the previous basic salary Xb becoming more than the policy line C or for any other reason, the total salary increase rate R can be corrected to the lower limit of “0.00.”

Similarly, the upper limit or the lower limit of the value the positional salary increase rate Rp can take may be set and the calculated positional salary increase rate Rp may be prevented from getting beyond the set upper limit or lower limit.

In the above-mentioned embodiment, a value obtained by dividing a value, obtained by multiplying the standard salary increase rate Rs by the policy line C, by the previous basic salary Xb is taken as the base salary increase rate Rbs (Numerical Expression 3) but the present invention is not limited to this. For example, only the standard salary increase rate Rs may be taken as the base salary increase rate Rbs, or a value obtained by dividing the standard salary increase rate Rs by the previous basic salary Xb may be taken or any other value may be used.

In the above-mentioned embodiment, the standard salary increase rate Rs is set for each rating and evaluation but the present invention is not limited to this. For example, the standard salary increase rate Rs may be set for each rating regardless of evaluation or may be set for each evaluation regardless of rating. The salary increase rate regardless of rating and evaluation may be taken as the standard salary increase rate Rs and the salary increase rate corresponding to a rating and/or an evaluation may be taken as the positional salary increase rate Rp. Further, the salary increase rate regardless of rating and evaluation may be respectively taken as the standard salary increase rate Rs and the positional salary increase rate Rp.

All the standard salary increase rates Rs corresponding to a rating and an evaluation of individual staff members are set in the basic salary information table 11b but the present invention is not limited to this. For example, the standard salary increase rate Rs of a rating or an evaluation of a specific staff member may be stored in the basic salary information table 11b and the standard salary increase rate Rs of any other rating or evaluation may be calculated based on the stored standard salary increase rate Rs.

When the standard salary increase rate Rs is calculated based on an evaluation of a specific staff member, for example, the following procedure can be used: the standard salary increase rate Rs of B evaluation at each rating is stored in the basic salary information table 11b; what is obtained by adding 0.03 to the standard salary increase rate Rs of B evaluation at each rating is taken as the standard salary increase rate Rs of S evaluation at that rating; what is obtained by adding 0.01 to the standard salary increase rate Rs of B evaluation is taken as the standard salary increase rate Rs of A evaluation at that rating; what is obtained by subtracting 0.01 from the standard salary increase rate Rs of B evaluation is taken as the standard salary increase rate Rs of C evaluation at that rating; and what is obtained by subtracting 0.02 from the standard salary increase rate Rs of B evaluation is taken as the standard salary increase rate Rs of D evaluation at that rating. At this time, a ratio at which addition or subtraction is made to or from the standard salary increase rate Rs of B evaluation may be different from rating to rating and from evaluation to evaluation.

When the standard salary increase rate Rs is calculated based on a rating of a specific staff member, for example, the following procedure can be used: Standard salary increase rates Rs of S to D evaluations at rating 3 are stored in the basic salary information table 11b; what is obtained by subtracting from each of the standard salary increase rates Rs of S to D evaluations at rating 3 is taken as standard salary increase rates Rs of S to D evaluations at rating 1; what is obtained by subtracting 0.01 from each of the standard salary increase rates Rs of S to D evaluations at rating 3 is taken as standard salary increase rates Rs of S to D evaluations at rating 2; what is obtained by adding 0.01 to each of the standard salary increase rates Rs of S to D evaluations at rating 3 is taken as standard salary increase rates Rs of S to D evaluations at rating 4; and what is obtained by adding 0.02 to each of the standard salary increase rates Rs of S to D evaluations at rating 3 is taken as standard salary increase rates Rs of S to D evaluations at rating 5. Also, at this time, a ratio at which addition or subtraction is made to or from the standard salary increase rates Rs of S to D evaluations at rating 3 may be made different from rating to rating and from evaluation to evaluation.

Further, when the standard salary increase rate Rs is calculated based on a rating and an evaluation of a specific staff member, for example, the following procedure can be used: the standard salary increase rate Rs of evaluation B at rating 3 is stored in the basic salary information table 11b; and the standard salary increase rate Rs of any other evaluation at any other rating is calculated based on the standard salary increase rate Rs of evaluation B at rating 3. At this time, a ratio at which addition or subtraction to or from the standard salary increase rate Rs of evaluation B at rating 3 according to a rating and an evaluation can be calculated similarly to the above-mentioned cases where the standard salary increase rate Rs is calculated based on an evaluation of a specific staff member or cases where the standard salary increase rate Rs is calculated based on a rating of a specific staff member.

In the above-mentioned embodiment, the policy line C is calculated from the lower limit amount A and the upper limit amount B but the present invention is not limited to this and the policy line C may be inputted from the input device 15. At this time, the policy line C may be set (inputted) together with the standard salary increase rate Rs, the development ratio d, and the reference positional salary increase rate Ru.

In the above-mentioned embodiment, the lower limit amount A and the upper limit amount B are inputted from the input device 15 and an average value of the lower limit amount A and the upper limit amount B is taken as the policy line C but the present invention is not limited to this. For example, the policy line C may be acquired from the input device 15 and the lower limit amount A and the upper limit amount B may be calculated from the policy line C. In this case, for example, an amount obtained by multiplying the policy line C by 0.7 may be taken as the lower limit amount A and an amount obtained by multiplying the policy line C by 1.1 may be taken as the upper limit amount B. Or, an amount obtained by subtracting 30000 from the policy line C may be taken as the lower limit amount A and an amount obtained by adding 30000 to the policy line C may be taken as the upper limit amount B.

The policy line C may be calculated only from the lower limit amount A or only from the upper limit amount B. For example, an amount obtained by multiplying the lower limit amount A by 1.1 may be taken as the policy line C and an amount obtained by subtracting 30000 from the upper limit amount B may be taken as the policy line C.

Further, the policy line C is not limited to an average value of the lower limit amount A and the upper limit amount B and may be set based on an amount at which the basic salary is most widely distributed at a relevant rating, for example, an average value or a median at that rating.

In the above-mentioned embodiment, the lower limit amount A, the upper limit amount B, the standard salary increase rate Rs, the development ratio d, and the reference positional salary increase rate Ru are inputted from the input device 15 and set in the basic salary information table 11b but the present invention is not limited to this. For example, when the lower limit amount A and/or the upper limit amount B at each rating varies by a certain ratio or by a certain amount because of wage raise, base-down, or the like, the following procedure may be used: the lower limit amount A and/or the upper limit amount B stored in the basic salary information table 11b may be varied according thereto; and the standard salary increase rate Rs, the development ratio d, and the reference positional salary increase rate Ru in the basic salary information table 11b are re-set to a value corresponding to the varied lower limit amount A and/or upper limit amount B.

In the above-mentioned embodiment, a number of continuance years at each rating obtained when a predetermined evaluation is continuously gained is stored in the number of continuance years table 11d but the present invention is not limited to this and a number of continuance years at each rating obtained when an evaluation to be gained is varied may be stored. In this case, the following procedure can be used: An evaluation gained in each year is stored in the number of continuance years table 11d together with a number of continuance years at each rating; in the processing of S53 in FIG. 7, an evaluation in a relevant year is acquired from the number of continuance years table lid; and in the processing of S55, the standard salary increase rate Rs corresponding to that evaluation is acquired from the basic salary information table lib. As a result, a more practical transition of the basic salary with variation in evaluation from year to year assumed can be acquired.

In the above-mentioned embodiment, in the basic salary calculation processing (S6) in FIG. 5A, the increased basic salary Xn is calculated for one time of salary increase. The present invention is not limited to this. Instead, by repeatedly performing the basic salary calculation processing (S6), the increased basic salary Xn obtained when salary increase is made a plurality of times (for example, the increased basic salary Xn five years later obtained when salary increase is made once per year) may be calculated.

Specifically, the lower limit amount A, the upper limit amount B, the policy line C, the standard salary increase rate Rs, the development ratio d, and the reference positional salary increase rate Ru at each rating are set in the basic salary information table 11b in FIG. 2A in advance. In addition, a rating, an evaluation, and the previous basic salary Xb of each staff member are set in the staff member information table 11c in FIG. 3A. Then, the basic salary calculation processing in FIG. 5A only has to be repeatedly performed.

In cases where the previous basic salary Xb is acquired in the processing of S22 at this time, the following procedure only has to be used: In the processing of S22 performed at a first time, the previous basic salary Xb of an Nth staff member is acquired from the staff member information table 11c; and at a second and following times, the increased basic salary Xn of the Nth staff member in the staff member information table 11c is acquired as the previous basic salary Xb.

As a result, the increased basic salary Xn obtained when salary increase is made a plurality of times is calculated with the lower limit amount A, the upper limit amount B, the policy line C, the standard salary increase rate Rs, the development ratio d, the reference positional salary increase rate Ru, an evaluation, and a rating fixed. Therefore, short-term or medium-term variation in the increased basic salary Xn especially with an evaluation or a rating fixed can be easily grasped.

In the above-mentioned embodiment, rating is divided into five stages, rating 1 to rating 5 but the present invention is not limited to this and rating may be divided into more than five stages or may be divided into less than five stages. Especially, rating may be provided only in one stage and a classification of staff members according to rating may be omitted.

As an example of the computer executing the basic salary calculation program 11a, the PC 1 has been referred to but the present invention is not limited to this and the basic salary calculation program 11a may be executed by any other computer, such as a tablet terminal or a smartphone. The basic salary calculation program 11a may be stored in ROM or the like and the present invention may be applied to a dedicated device that executes only the basic salary calculation program 11a.

The basic salary calculation program being thus described, it will be apparent that the same may be varied in many ways. Such variations are not to be regarded as a departure from the spirit and scope of the invention, and all such modifications as would be apparent to one of ordinary skill in the art are intended to be included within the scope of the following claims.

What is claimed is:

1. A non-transitory computer-readable medium storing a basic salary calculation program for causing a computer equipped with a storage unit to perform basic salary calculation processing,
wherein the storage unit is caused to function as a staff member information storage means that stores a previous basic salary for each staff member, the basic salary calculation program causing the computer to perform:
a staff member information acquisition step of acquiring the previous basic salary of one staff member from the staff member information storage means;
a PL acquisition step of acquiring a policy line for the basic salary;
a position calculation step of calculating a basic salary position based on a difference between the previous basic salary acquired at the staff member information acquisition step and the policy line acquired at the PL acquisition step;
a positional salary increase rate calculation step of calculating a positional salary increase rate corresponding to the basic salary position calculated at the position calculation step;
a total salary increase rate calculation step of calculating a total salary increase rate that is a salary increase rate including the positional salary increase rate calculated at the positional salary increase rate calculation step; and
a basic salary calculation step of using the total salary increase rate calculated at the total salary increase rate calculation step and the previous basic salary acquired at the staff member information acquisition step to calculate an increased basic salary of the one staff member.

2. The non-transitory computer-readable medium according to claim 1,
wherein the positional salary increase rate calculation step is to calculate the positional salary increase rate from an enumeration function using as input the basic salary position calculated at the position calculation step,
wherein the positional salary increase rate at the policy line is taken as a PL positional salary increase rate, and
wherein as the positional salary increase rate, the enumeration function,
when the previous basic salary acquired at the staff member information acquisition step is less than the policy line acquired at the PL acquisition step, outputs a salary increase rate equal to or more than the PL positional salary increase rate, and
when the previous basic salary acquired at the staff member information acquisition step is more than the policy line acquired at the PL acquisition step, outputs a salary increase rate equal to or less than the PL positional salary increase rate.

3. The non-transitory computer-readable medium according to claim 2,
wherein the enumeration function is set based on the policy line and the PL positional salary increase rate, and a reference position basic salary that is the basic salary different from the policy line by a predetermined amount and the reference positional salary increase rate that is the positional salary increase rate at that reference position basic salary.

4. The non-transitory computer-readable medium according to claim 3,
wherein either a lower limit amount or an upper limit amount of the basic salary is set as the reference position basic salary, and
wherein the positional salary increase rate at the lower limit amount or the upper limit amount of the basic salary set as the reference position basic salary is set as the reference positional salary increase rate.

5. The non-transitory computer-readable medium according to claim 2,
wherein the computer is caused to perform a standard salary increase rate acquisition step of acquiring a standard salary increase rate at the policy line acquired at the PL acquisition step, and
wherein the total salary increase rate calculation step is to calculate the total salary increase rate by the standard salary increase rate acquired at the standard salary increase rate acquisition step and the positional salary increase rate calculated at the positional salary increase rate calculation step.

6. The non-transitory computer-readable medium according to claim 5,
wherein the computer is caused to perform a base salary increase rate calculation step of calculating a base salary increase rate by multiplying the standard salary increase rate acquired at the standard salary increase rate acquisition step and the policy line acquired at the PL acquisition step and dividing the resulting multiplied value by the previous basic salary acquired at the staff member information acquisition step,
wherein the total salary increase rate calculation step is to add the base salary increase rate calculated at the base salary increase rate calculation step and the positional salary increase rate calculated at the positional salary increase rate calculation step to calculate the total salary increase rate, and
wherein the basic salary calculation step is to add a salary increase amount, obtained by multiplying the total salary increase rate calculated at the total salary increase rate calculation step and the previous basic salary acquired at the one staff member information acquisition step, to the previous basic salary to calculate the increased basic salary of the one staff member.

7. The non-transitory computer-readable medium according to claim 5,
wherein the staff member information storage means stores an evaluation from each the staff member's job,
wherein the staff member information acquisition step is to acquire the evaluation of one staff member from the staff member information storage means, and
wherein the standard salary increase rate acquisition step is to acquire the standard salary increase rate corresponding to the evaluation acquired at the staff member information acquisition step.

8. The non-transitory computer-readable medium according to claim 6,
wherein the staff member information storage means stores an evaluation from each the staff member's job,
wherein the staff member information acquisition step is to acquire the evaluation of one staff member from the staff member information storage means, and
wherein the standard salary increase rate acquisition step is to acquire the standard salary increase rate corresponding to the evaluation acquired at the staff member information acquisition step.

9. The non-transitory computer-readable medium according to any of claim 5,
wherein the staff member information storage means stores a rating of each the staff member,
wherein the staff member information acquisition step is to acquire the rating of one staff member from the staff member information storage means,
wherein the PL acquisition step is to acquire the policy line corresponding to the rating acquired at the staff member information acquisition step, and
wherein the standard salary increase rate acquisition step is to acquire the standard salary increase rate at the policy line corresponding to the rating acquired at the PL acquisition step.

10. The non-transitory computer-readable medium according to claim 6,
wherein the staff member information storage means stores a rating of each the staff member,
wherein the staff member information acquisition step is to acquire the rating of one staff member from the staff member information storage means,
wherein the PL acquisition step is to acquire the policy line corresponding to the rating acquired at the staff member information acquisition step, and
wherein the standard salary increase rate acquisition step is to acquire the standard salary increase rate at the policy line corresponding to the rating acquired at the PL acquisition step.

11. The non-transitory computer-readable medium according to claim 5,
wherein the staff member information storage means stores an evaluation and a rating of each the staff member,
wherein the staff member information acquisition step is to acquire the evaluation and the rating of one staff member from the staff member information storage means,
wherein the PL acquisition step is to acquire the policy line corresponding to the rating acquired at the staff member information acquisition step, and
wherein the standard salary increase rate acquisition step is to acquire the standard salary increase rate corresponding to the evaluation acquired at the staff member information acquisition step and at the policy line corresponding to the rating acquired at the PL acquisition step.

12. The non-transitory computer-readable medium according to claim 1,
wherein the staff member information storage means stores an evaluation from each the staff member's job,
wherein the staff member information acquisition step is to acquire the evaluation of one staff member from the staff member information storage means, and
wherein the positional salary increase rate calculation step is to calculate the positional salary increase rate corresponding to the basic salary position calculated at the position calculation step and the evaluation acquired at the staff member information acquisition step.

13. The non-transitory computer-readable medium according to claim 5,
wherein the staff member information storage means stores an evaluation from each the staff member's job,
wherein the staff member information acquisition step is to acquire the evaluation of one staff member from the staff member information storage means, and
wherein the positional salary increase rate calculation step is to calculate the positional salary increase rate corresponding to the basic salary position calculated at the position calculation step and the evaluation acquired at the staff member information acquisition step.

14. The non-transitory computer-readable medium according to claim 6,
wherein the staff member information storage means stores an evaluation from each the staff member's job,
wherein the staff member information acquisition step is to acquire the evaluation of one staff member from the staff member information storage means, and
wherein the positional salary increase rate calculation step is to calculate the positional salary increase rate corresponding to the basic salary position calculated at the position calculation step and the evaluation acquired at the staff member information acquisition step.

15. The non-transitory computer-readable medium according to claim 1,
wherein the staff member information storage means stores a rating of each the staff member,
wherein the staff member information acquisition step is to acquire the rating of one staff member from the staff member information storage means,
wherein the PL acquisition step is to acquire the policy line corresponding to the rating acquired at the staff member information acquisition step, and
wherein the positional salary increase rate calculation step is to calculate the positional salary increase rate corresponding to the basic salary position calculated at the position calculation step and the rating acquired at the staff member information acquisition step.

16. The non-transitory computer-readable medium according to claim 5,
wherein the staff member information storage means stores a rating of each the staff member,
wherein the staff member information acquisition step is to acquire the rating of one staff member from the staff member information storage means,
wherein the PL acquisition step is to acquire the policy line corresponding to the rating acquired at the staff member information acquisition step, and
wherein the positional salary increase rate calculation step is to calculate the positional salary increase rate corresponding to the basic salary position calculated at the position calculation step and the rating acquired at the staff member information acquisition step.

17. The non-transitory computer-readable medium according to claim 6,
wherein the staff member information storage means stores a rating of each the staff member,
wherein the staff member information acquisition step is to acquire the rating of one staff member from the staff member information storage means,
wherein the PL acquisition step is to acquire the policy line corresponding to the rating acquired at the staff member information acquisition step, and
wherein the positional salary increase rate calculation step is to calculate the positional salary increase rate corresponding to the basic salary position calculated at the position calculation step and the rating acquired at the staff member information acquisition step.

18. The non-transitory computer-readable medium according to claim 1,
wherein the staff member information storage means stores an evaluation and a rating of each the staff member,
wherein the staff member information acquisition step is to acquire the evaluation and the rating of one staff member from the staff member information storage means,
wherein the PL acquisition step is to acquire the policy line corresponding to the rating acquired at the staff member information acquisition step, and
wherein the positional salary increase rate calculation step is to calculate the positional salary increase rate corresponding to the basic salary position calculated at the position calculation step and the evaluation and the rating acquired at the staff member information acquisition step.

19. The non-transitory computer-readable medium according to claim 9,
wherein the storage unit is caused to function as a number of continuance years storage means that stores a number of continuance years at each the rating,
wherein a number of continuance years acquisition step of acquiring a number of continuance years from the number of continuance years storage means is provided,
wherein the PL acquisition step is to acquire the policy line corresponding to the rating equivalent to the number of continuance years acquired at the number of continuance years acquisition step,
wherein the basic salary calculation step is to calculate the increased basic salary by an amount equivalent to the number of continuance years acquired at the number of continuance years acquisition step, and
wherein the computer is caused to perform the basic salary transition acquisition step of acquiring a transition of the basic salary calculated at the basic salary calculation step.

20. The non-transitory computer-readable medium according to claim 15,
wherein the storage unit is caused to function as a number of continuance years storage means that stores a number of continuance years at each the rating,
wherein a number of continuance years acquisition step of acquiring a number of continuance years from the number of continuance years storage means is provided,
wherein the PL acquisition step is to acquire the policy line corresponding to the rating equivalent to the number of continuance years acquired at the number of continuance years acquisition step,
wherein the basic salary calculation step is to calculate the increased basic salary by an amount equivalent to the number of continuance years acquired at the number of continuance years acquisition step, and
wherein the computer is caused to perform the basic salary transition acquisition step of acquiring a transition of the basic salary calculated at the basic salary calculation step.
